(19) United States
(12) Patent Application Publication
(10) Pub. No.: US 2015/0215860 A1
(43) Pub. Date: Jul. 30, 2015

(54) SUBSCRIPTION ACQUISITION TIME

(71) Applicant: QUALCOMM Incorporated, San Diego, CA (US)

(72) Inventors: Mahender Reddy Akkapally, Hyderabad (IN); Rammohan Kandlakunta, Hyderabad (IN)

(73) Assignee: QUALCOMM Incorporated, San Diego, CA (US)

(21) Appl. No.: 14/168,145

(22) Filed: Jan. 30, 2014

(51) Int. Cl. H04W 48/20; H04B 1/7117

(52) U.S. Cl. CPC H04W 48/20; H04B 1/7117

(57) ABSTRACT

A method of reacquiring subscription service from a communication cell by a user equipment (UE) includes: during an active call in a dedicated channel (DCH) state, allocating one or more of a plurality of fingers of a rake receiver of the UE to decode a Master Information Block (MIB) value tag and System Information Blocks (SIBs) of an active set (ASET) of cell signals, and storing decoded SIB information and a value of the MIB value tag in a storage of the UE; when the active call is released, determining a cell having a strongest signal as a target cell for reacquisition, and comparing the stored value of the MIB value tag with a value of a broadcast MIB value tag; and if the value of the stored value of the MIB value tag is the same as the value of the broadcast MIB value tag, reading the SIB information of the target cell from storage of the UE, and reacquiring the target cell.

### BACKGROUND

1. Field

Aspects of the present disclosure relate generally to wireless communications, and more particularly to reducing cell reacquisition time a multi-SIM user equipment.

2. Related Art

In a multi-Subscriber Identity Module (SIM) user equipment (UE) case, when Subscription1 is in a Wideband CDMA Dedicated Channel (WCDMA DCH) state the UE may go through multiple soft/softer handovers. In this scenario, after a call release on Subscription1, the UE has to perform a cell selection procedure to reacquire the Subscription1 service. During this cell selection process, the UE attempts to reacquire a cell from the previously active set (ASET), i.e., an active set of cell signals, having a strongest signal at the time the call was released.

A system information message is broadcast repeatedly on the broadcast control channel (BCCH) and includes the Master Information Block (MIB) and several System Information Blocks (SIBs). Conventionally, the UE reads the SIBs of the target cell during the reacquisition process. The service acquisition time depends on the time taken to read the SIBs of the target cell. This SIB reading process can take an arbitrary amount of time (typically 2 to 4 seconds) which affects the Acquisition/Page performance of other Subscriptions on the multi-sim UE.

### SUMMARY

Apparatuses, systems, and methods for reducing cell reacquisition time of a multi-SIM user equipment are provided.

According to an aspect of the present inventive concept there is provided a method of reacquiring subscription service from a communication cell by a user equipment (UE). The method may include: during an active call in a dedicated channel (DCH) state, allocating one or more of a plurality of fingers of a rake receiver of the UE to decode a Master Information Block (MIB) value tag and System Information Blocks (SIBs) of an active set (ASET) of cell signals, and storing decoded SIB information and a value of the MIB value tag in a storage of the UE; when the active call is released, determining a cell having a strongest signal as a target cell for reacquisition, and comparing the stored value of the MIB value tag with a value of a broadcast MIB value tag; and if the value of the stored value of the MIB value tag is the same as the value of the broadcast MIB value tag, reading the SIB information of the target cell from storage of the UE, and reacquiring the target cell.

According to another aspect of the present invention there is provided a user equipment. The user equipment may include: a control unit configured to control operation of the UE; one or more subscriber identity modules (SIM) containing identification information for at least one communication network; a communication unit configured to receive and decode a master information block (MIB) and a plurality of system information blocks (SIBs) of an active set (ASET) of cell signals of the at least one communication network; and a storage configured to store a decoded value of a MIB value tag and decoded SIB information of one or more of the plurality of SIBs. During an active call in a dedicated channel (DCH) state, the control unit causes the storage to store the decoded value of a MIB value tag and decoded SIB information.

The communication unit may include a rake receiver including a plurality of fingers. During an active call in a dedicated channel (DCH) state, the control unit may allocate one or more of the plurality of fingers of the rake receiver to decode the MIB value tag and the SIBs of the ASET.

According to another aspect of the present invention there is provided a communication system. The communication system may include: at least one communication network; and at least one user equipment (UE). The UE may include: a control unit configured to control operation of the UE; at least one subscriber identity module (SIM) containing identification information for the least one communication network; a communication unit configured to receive and decode a master information block (MIB) and a plurality of system information blocks (SIBs) of an active set (ASET) of cell signals of the at least one communication network; and a storage configured to store a decoded value of a MIB value tag and decoded SIB information of one or more of the plurality of SIBs. During an active call in a dedicated channel (DCH) state on the at least one communication network, the control unit causes the storage to store the decoded value of a MIB value tag and decoded SIB information.

The communication unit of the UE may include a rake receiver including a plurality of fingers. During an active call in a dedicated channel (DCH) state on the at least one communication network, the control unit of the UE allocates one or more of the plurality of fingers of the rake receiver to decode the MIB value tag and the SIBs of the ASET.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating an apparatus according to an example embodiment of the present inventive concept;

FIG. 2 illustrates a UE in a cellular network according to an example embodiment of the present inventive concept; and

FIG. 3 is a flowchart illustrating a method according to an example embodiment of the present inventive concept.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

The present inventive concept provides systems and methods to reduce cell reacquisition time by allocating fingers of a UE rake receiver to decode SIBs of an active set (ASET) and a MIB value tag while Subscription1 is in a WCDMA DCH state, and store the decoded SIB information and a value of the MIB value tag in UE storage.

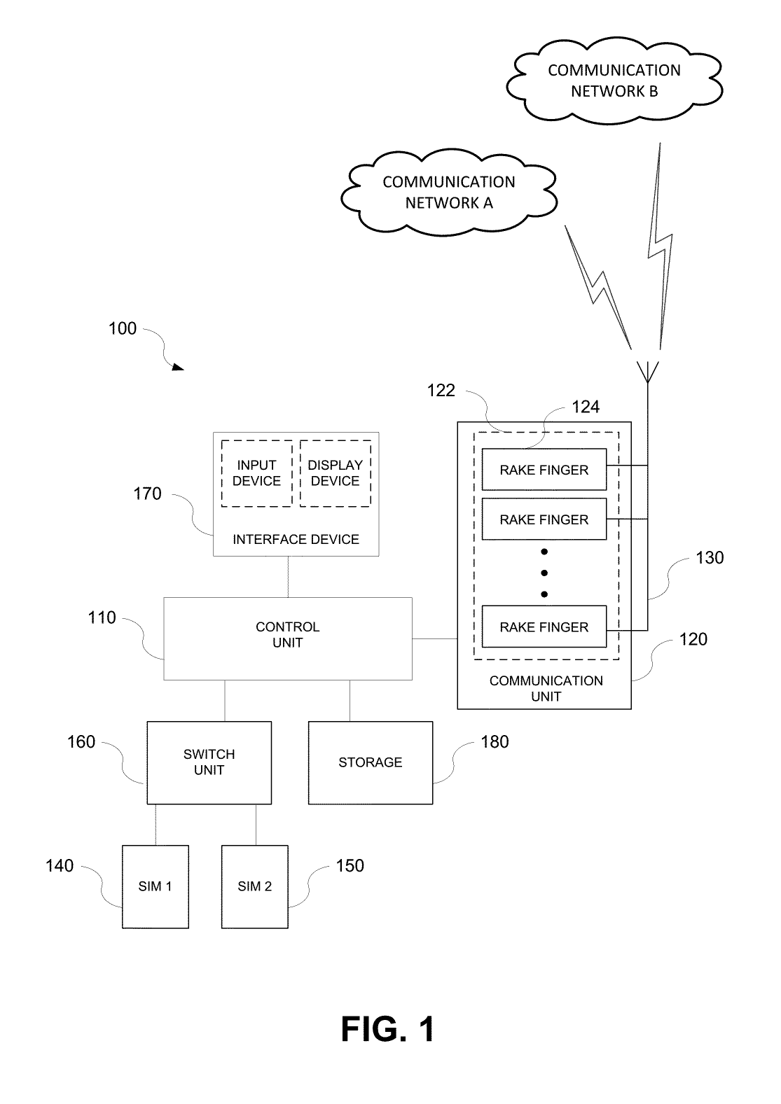

FIG. 1 is a block diagram illustrating an apparatus according to an example embodiment of the present inventive concept. As illustrated in FIG. 1, a UE 100 may include a control unit 110, a communications unit 120, an antenna 130, a first SIM 140, a second SIM 150, a switch unit 160, a user interface device 170, and storage 180. The UE 100 may be a mobile device, for example but not limited to, a mobile telephone, smartphone, tablet, computer, etc., capable of mobile communications with one or more wireless networks.

The first and second SIMs 140, 150 each contain data necessary to subscribe the mobile device 100 to a communication network. For example, the first SIM 140 may subscribe the mobile device 100 with communication network A and the second SIM 150 may subscribe the mobile device 100 with communication network B. In some example embodiments, mobile devices may have more than two SIMs and may be capable of accessing services from more than two different networks. Communication networks A and B may be operated by the same or different service providers, and/or may support the same or different technologies, for example, but not limited to, WCDMA and GSM.

The control unit 110 controls overall operation of the UE 100 including control of the communications unit 120, switch unit 160, user interface device 170, and storage 180. The control unit 110 may be a programmable device, for example, but not limited to, a microprocessor or microcontroller. The control unit 110 may control the switch unit 160 to select the first SIM 140 or the second SIM 150 based on which subscription is active. The storage 180 may store application programs necessary for operation of the mobile device 100 that are executed by the control unit 110, as well as application data and user data.

The user interface device 170 may include a user input device 172 and a display device 174. The user input device 172 may be, for example, but not limited to, a keypad and/or a touch screen. The display device 174 may be, for example, but not limited to, a liquid crystal display (LCD). One of ordinary skill in the art will appreciate that other user input and display devices may be used without departing from the scope of the present inventive concept.

The communication unit 120 may include a rake receiver 122 having a plurality of fingers 124 configured to decode signals received from various signal paths in a multi-path environment. For example, a rake receiver may have twelve fingers; however, not all of the fingers may be used at one time to decode received multi-path signals, and one or more fingers 124 may be allocated to decode the MIB and SIBs of cells in the ASET. An ASET may include six cells. In an example embodiment of the present inventive concept, while the UE is on a dedicated call, two of the fingers 124 may be allocated to cycle through and decode the MIB and SIBs of all the cells in the ASET.

The MIB is used to specify what system information blocks are in use in a cell, and how they should be accessed. It includes system information including the scheduling information for the other SIBs that must be read by the UE in order for it to perform the basic operations regarding cell reselection. The UE must be able to read the MIB, otherwise it cannot read any of the other SIBs. The MIB information includes a value tag that is related to the values of the information elements in a SIB. If the information is changed, the value tag of the SIB is changed and the value tag of the MIB is updated accordingly. The received SIB information is decoded by the allocated fingers 124 during the dedicated call and may be stored in the storage 180 together with the value of the MIB value tag.

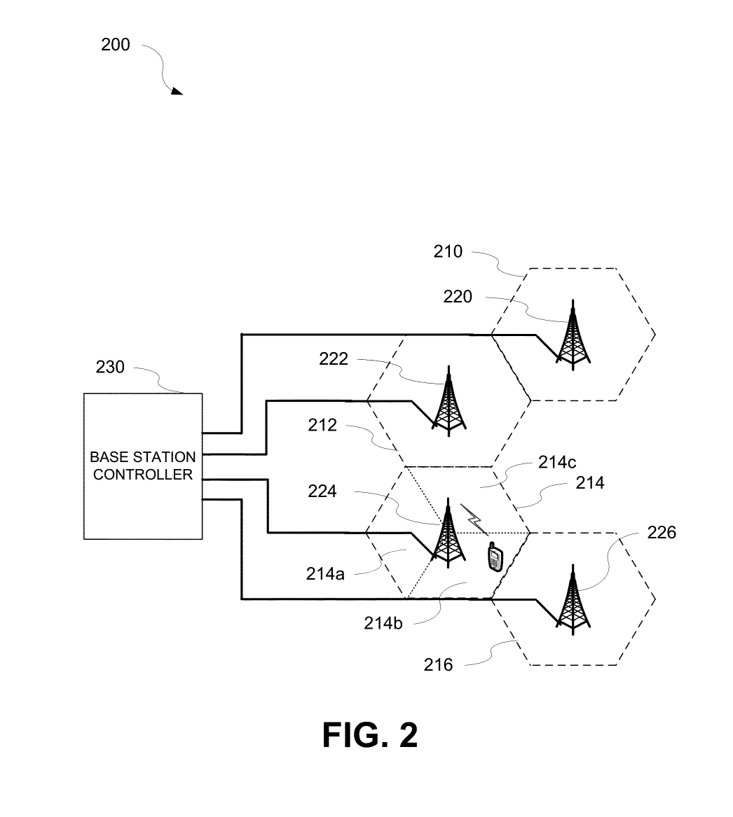

When Subscription1 is in a WCDMA DCH state, the UE may go through multiple soft/softer handovers. FIG. 2 illustrates a UE in a cellular network according to an example embodiment of the present inventive concept. As illustrated in FIG. 2, a cellular network may include a plurality of cells 210, 212, 214, 216, each having a base station 220, 222, 224, 226 providing communication within each cell. A base station controller 230 provides control and communication among the base stations 220-226. Further, each cell may be divided into a plurality of sectors. For example, cell 214 is divided into three sectors 214a, 214b, and 214c, served by directional antennas on the base station 224. UE 240 may move from one sector to another sector within the cell or may move to another cell, in either case necessitating a handoff.

A soft handover is a make-before-break connection of the UE when moving between cells. The UE on a call moves from one base station (BS) to another, but the UE starts communicating with a new BS before terminating communications with the old BS. A softer handover is also a make-before-break connection that occurs when the UE is communicating with two sectors within a cell. To facilitate handoff, each cell repeatedly broadcasts a system information message on the broadcast control channel (BCCH). The system information message includes the Master Information Block (MIB) and several SIBs. Table 1 lists the different types of SIBs.

TABLE 1

| | |
|---|---|
| SIB1 | The system information block type 1 contains NAS system information as well as |
| | UE timers and counters to be used in idle mode and in connected mode. |
| SIB2 | The system information block type 2 contains the URA identity. |
| SIB3 | The system information block type 3 contains parameters for cell selection and re- |
| | selection. |
| SIB4 | The system information block type 4 contains parameters for cell selection and re- |
| | selection to be used in connected mode. |
| SIB5 | The system information block type 5 contains parameters for the configuration of the |
| | common physical channels in the cell. |
| SIB6 | The system information block type 6 contains parameters for the configuration of the |
| | common and shared physical channels to be used in connected mode. |
| SIB7 | The system information block type 7 contains the fast changing parameters UL |
| | interference and Dynamic persistence level. |
| SIB8 | The system information block type 8 contains static CPCH information to be used in |
| | the cell. |
| SIB9 | The system information block type 9 contains CPCH information to be used in the |
| | cell. |
| SIB10 | The system information block type 10 contains information to be used by UEs |
| | having their DCH controlled by a DRAC procedure. |
| SIB11 | The system information block type 11 contains measurement control information to |
| | be used in the cell. |
| SIB12 | The system information block type 12 contains measurement control information to |
| | be used in connected mode. |
| SIB13 | The system information block type 13 contains ANSI-41 system information. |
| SIB14 | Only for TDD |
| SIB15 | The system information block type 15 contains information useful for UE-based or |
| | UE-assisted positioning methods. |
| SIB16 | The system information block type 16 contains radio bearer, transport channel and |
| | physical channel parameters to be stored by UE in idle and connected mode for use |
| | during handover to UTRAN. |
| SIB17 | Only for TDD |
| SIB18 | The System Information Block type 18 contains PLMN identities of neighbouring |
| | cells to be considered in idle mode as well as in connected mode. |

In some example embodiments, the UE 100 contains sufficient storage to store information received and decoded during the WCDMA DCH call from all of the SIBs. In some example embodiments, only received and decoded information from SIBs 1, 3, 5, 7, and 11 need be stored.

Conventionally, the UE reads the SIBs of the target cell during the reacquisition process. Thus, the conventional service acquisition time depends on the time taken to read the SIBs of the target cell. This conventional SIB reading process can take an arbitrary amount of time (e.g., 2 to 4 seconds) which affects the Acquisition/Page performance of other Subscriptions on a multi-sim UE.

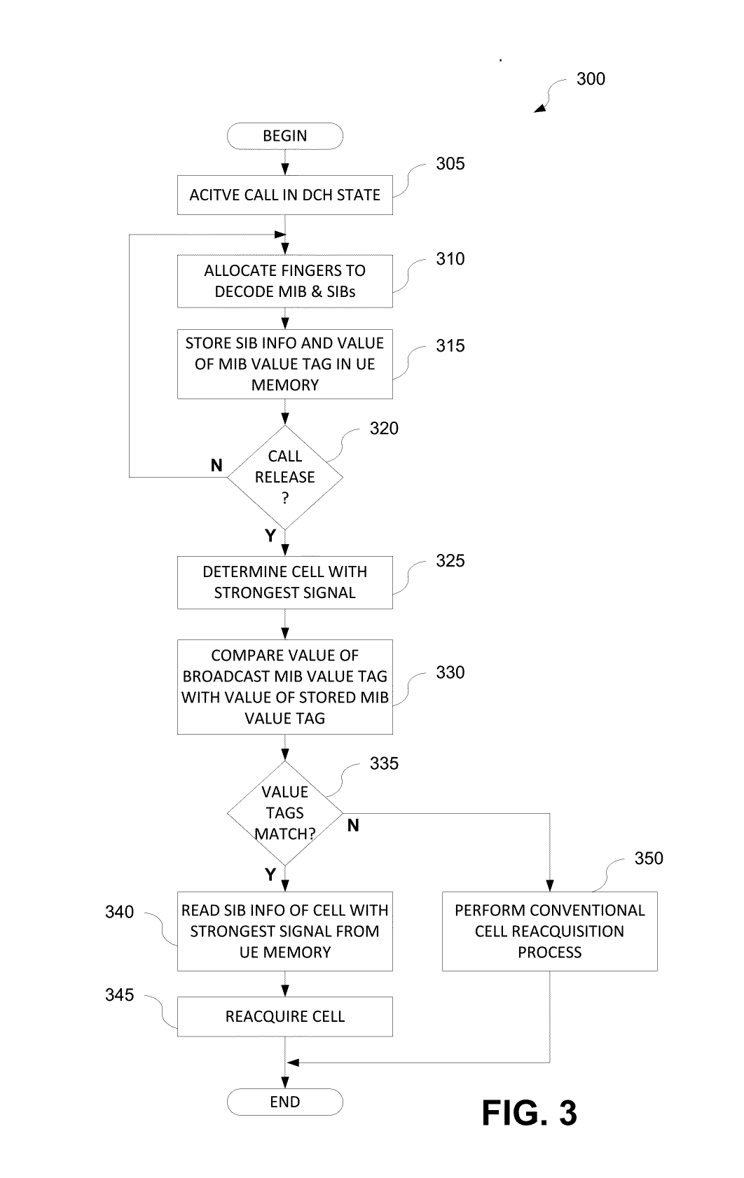

FIG. 3 is a flowchart illustrating a method according to an example embodiment of the present inventive concept. Referring to FIG. 3, while a call is active in the DCH state (305), the control unit 110 causes the communication unit 120 to allocate one or more fingers 124 of the rake receiver 122 to read and decode the broadcast MIB and SIBs (310). The control unit 110 causes a decoded value of the MIB value tag and decoded information from the SIBs to be stored in the storage 180 (S315). If the storage 180 contains sufficient capacity, information from all of the SIBs of all cells in the ASET may be stored; otherwise, information from at least SIBs 1, 3, 5, 7, and 11 may be stored in the storage 180.

When the call is released (320-Y), the control unit 110 of the UE 100 determines the cell with the strongest signal as a target cell to be reacquired (325). The control unit 110 causes the value of the MIB value tag stored in the storage 180 to be read and compared to the value of the broadcast MIB value tag (330).

If the values of the stored MIB value tag and the broadcast MIB value tag are the same, then the SIB information has not changed and the SIB information of the cell having the strongest signal at the time the call was released is read from storage 180 (340). The cell whose SIB information was read from storage 180 is reacquired by the UE (345). Thus, according to the present inventive concept SIB read time is reduced because the stored SIB information is read from storage 180 rather than being received and decoded from the broadcast SIB after call release.

On the other hand, if the values of the stored MIB value tag and the broadcast MIB value tag are not the same, then the SIB information has changed and the SIB information of the cell having the strongest signal at the time the call was released is decoded from the broadcast SIBs.

While certain embodiments have been described, these embodiments have been presented by way of example only, and are not intended to limit the scope of the protection. The apparatuses, methods, and systems described herein may be embodied in a variety of other forms. Various omissions, substitutions, and/or changes in the form of the example apparatuses, methods, and systems described in this disclosure may be made without departing from the spirit of the protection.

The accompanying claims and their equivalents are intended to cover such forms or modifications as would fall within the scope and spirit of the protection. For example, the example apparatuses, methods, and systems disclosed herein can be applied to multi-SIM mobile devices subscribing to multiple communication networks and/or communication technologies. The various components illustrated in the figures may be implemented as, for example, but not limited to, software and/or firmware on a processor, ASIC/FPGA, or dedicated hardware. Also, the features and attributes of the specific example embodiments disclosed above may be combined in different ways to form additional embodiments, all of which fall within the scope of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method of reacquiring subscription service from a communication cell by a user equipment (UE), the method comprising:
during an active call in a dedicated channel (DCH) state, allocating one or more of a plurality of fingers of a rake receiver of the UE to decode a Master Information Block (MIB) value tag and System Information Blocks (SIBs) of an active set (ASET) of cell signals, and storing decoded SIB information and a value of the MIB value tag in a storage of the UE;
when the active call is released, determining a cell having a strongest signal as a target cell for reacquisition, and comparing the stored value of the MIB value tag with a value of a broadcast MIB value tag; and
if the value of the stored value of the MIB value tag is the same as the value of the broadcast MIB value tag, reading the SIB information of the target cell from storage of the UE, and reacquiring the target cell.

2. The method of claim 1, further comprising if the value of the stored MIB value tag is not the same as the value of the broadcast MIB value tag, performing a conventional cell reacquisition process.

3. The method of claim 1, wherein the storing decoded SIB information comprises storing SIB information of only SIBs 1, 3, 5, 7, and 11.

4. The method of claim 1, wherein the storing decoded SIB information comprises storing SIB information of all the SIBs of all cells in the ASET.

6. A user equipment (UE), comprising:
a control unit configured to control operation of the UE;
one or more subscriber identity modules (SIM) containing identification information for at least one communication network;
a communication unit configured to receive and decode a master information block (MIB) and a plurality of system information blocks (SIBs) of an active set (ASET) of cell signals of the at least one communication network; and
a storage configured to store a decoded value of a MIB value tag and decoded SIB information of one or more of the plurality of SIBs,
wherein during an active call in a dedicated channel (DCH) state, the control unit causes the storage to store the decoded value of a MIB value tag and decoded SIB information.

7. The apparatus of claim 6, wherein the communication unit comprises a rake receiver comprising a plurality of fingers.

8. The apparatus of claim 7, wherein during an active call in a dedicated channel (DCH) state, the control unit allocates one or more of the plurality of fingers of the rake receiver to decode the MIB value tag and the SIBs of the ASET.

9. The apparatus of claim 6, wherein the control unit causes the storage to store SIB information of only SIBs 1, 3, 5, 7, and 11.

10. The apparatus of claim 6, wherein the control unit causes the storage to store SIB information of all the SIBs of all cells in the ASET.

11. The apparatus of claim 6, wherein the UE is one of a mobile telephone, a smartphone, tablet, and a portable computer.

12. A communication system, comprising:
at least one communication network; and
at least one user equipment (UE), the UE comprising:
a control unit configured to control operation of the UE;
at least one subscriber identity module (SIM) containing identification information for the least one communication network;
a communication unit configured to receive and decode a master information block (MIB) and a plurality of system information blocks (SIBs) of an active set (ASET) of cell signals of the at least one communication network; and
a storage configured to store a decoded value of a MIB value tag and decoded SIB information of one or more of the plurality of SIBs,
wherein during an active call in a dedicated channel (DCH) state on the at least one communication network, the control unit causes the storage to store the decoded value of a MIB value tag and decoded SIB information.

13. The communication system of claim 12, wherein the communication unit of the UE comprises a rake receiver comprising a plurality of fingers.

14. The communication system of claim 13, wherein during an active call in a dedicated channel (DCH) state on the at least one communication network, the control unit of the UE allocates one or more of the plurality of fingers of the rake receiver to decode the MIB value tag and the SIBs of the ASET.

15. The communication system of claim 12, wherein the control unit of the UE causes the storage of the UE to store SIB information of only SIBs 1, 3, 5, 7, and 11.

16. The communication system of claim 12, wherein the control unit of the UE causes the storage of the UE to store SIB information of all the SIBs of all cells in the ASET.

17. The communication system of claim 12, wherein the UE is one of a mobile telephone, a smartphone, tablet, and a portable computer.
